(19) United States
(12) Patent Application Publication
(10) Pub. No.: US 2018/0276397 A1
(43) Pub. Date: Sep. 27, 2018

(54) Systems and Methods for Secure, Message-Based Delivery of Mobile Application Requests

(71) Applicant: MATTHEW HOFFMAN, DANVlLLE, CA (US)

(72) Inventor: MATTHEW HOFFMAN, DANVlLLE, CA (US)

(21) Appl. No.: 15/466,777

(22) Filed: Mar. 22, 2017

(51) Int. Cl. G06F 21/60; H04W 12/02; H04N 1/00; H04N 1/411

(52) U.S. Cl. CPC G06F 21/608; H04W 12/02; H04N 2201/0082; H04N 1/00307; H04N 1/411; H04N 1/00233

(57) ABSTRACT

The disclosed invention comprises Systems and Methods for delivery of mobile applications' requests for services to network devices or apparatus in a secure environment. The invention features web-based configuration services allowing for the definition of delivery systems' components, including mobile devices, delivery channels, machine handlers, endpoints and pre-authentications. Machine handlers are pre-authenticated to access endpoints. Mobile applications encode their requests and send these encoded requests in message bodies to a message server. Delivery handlers send these messages to machine handlers for specified endpoints based on configuration. Machine handlers decode and submit the requests to endpoints, e.g. a printer. The invention therefore allows a user to send a mobile application request to a secured network device, such as an endpoint printer, with no intervening actions such as unwanted security requests.

### FIELD OF THE DISCLOSURE

The present invention relates to the management of requests by mobile applications for services from, or actions by, network devices, specifically, to systems and methods for a secure, message-based delivery of print requests.

### BACKGROUND

Mobilization of today's workforce continues to be an important trend in business. Businesses rely on mobile devices and Cloud-based applications to increase productivity and reduce costs. Mobile devices, such as smartphones, are now commonly being adapted for use in business settings. For example, a retailer's point of sale can be its salesperson's mobile device while interacting with a customer on the sales floor. A biotechnology company's scientific equipment repair can be managed, step by step, using a repair person's mobile device interfacing with an Internet application. As a result, applications resident on mobile devices must be able to send requests in a secure environment.

One key requirement is mobile printing. Many business processes, even those that have been mobilized to some extent, require printing of documents, labels or other materials. Mobile workers still need to print timely, efficiently, and in a secure environment. However, printing to network-connected printers within a corporate network remains a challenge. Corporate, enterprise, business and other similar closed networks or intranets often have security and policy procedures in place. Firewalls protect printers from spam and malware. Policies track costs and prevent waste.

Some Internet-based applications do not allow print requests to be sent directly to network printers without first requiring responses to a prompt as a security measure. This security measure can be disruptive to a business's workflow. The measure requires, e.g., workers to take time away from the task at hand to interact with the prompt, with, e.g., a terminal mouse or keyboard interface either proximate to—or often a substantial distance away from—them. This disruption can result in the inadvertent cancellation of print jobs so that important business data is not recorded or requisite print jobs are missed.

What is needed, therefore, are systems and methods for mobile printing that allow for printing to secured, network-connected printers without intervening actions.

### SUMMARY

The disclosed invention comprises Systems and Methods for delivery of mobile applications' requests for services to network devices or apparatus in a secure environment. Web-based configuration services allow for the definition of a delivery systems' components, including mobile devices, delivery channels, machine handlers, endpoints and pre-authentications. Machine handlers, e.g., may be pre-authenticated to access endpoints. Mobile applications encode their requests and send those encoded requests in messages to a message server. Delivery handlers send messages to machine handler for the specified endpoints based on configuration. Machine handlers decode and submit the request to endpoints. The invention therefore allows a user to send a mobile application request to a secured network device, such as an endpoint printer, with no intervening actions.

### BRIEF DESCRIPTION OF THE DRAWINGS

The drawings described herein are for illustrative purposes only of selected embodiments and not all possible implementations and are not intended to limit the scope of the present disclosure.

FIG. 1: Block flow diagram illustrating Secure, Message-Based, Delivery System for Mobile Application Requests.

FIG. 2: Block flow diagram illustrating Secure, Message-Based, Mobile Printing System.

FIG. 3: Block flow diagram illustrating Creating and Posting Byte-Encoded File for Printing.

FIG. 4: Block flow diagram illustrating Processing Messages.

FIG. 4A: Block flow diagram further illustrating Processing Messages.

FIG. 5: Block flow diagram illustrating Delivering Messages and Printing Requested Files.

FIG. 5A: Block flow diagram illustrating Delivering Messages and Printing Requested Files.

### DEFINITIONS

Configuration: collection of identifiers, definitions, parameters and parameter values that define the components of a delivery system for mobile application requests, such as a mobile printing system.

Configuration Services: module that provides for the definition and modification of the delivery system for mobile application requests.

Configuration Services Server: The Server (computer program providing functionality for clients) which utilizes the configuration services module to provide functions for mobile application requests, and other functions disclosed infra.

Database: an organized collection of information.

Define (verb): to configure a system, setting system parameters, devices and functions.

Decode: convert coded information into its original form.

Delivery Handler: module that deliver messages to Machine Handlers.

Delivery system for mobile application requests: system for delivery and receipt of application requests over a network.

Encode: convert information into another form.

Endpoint: general term for network-connected devices that can receive information.

Machine Handler: module that decodes messages and sends the decoded requests to endpoints.

Message: a unit of information transferred via a network from one entity to another entity.

Message Queue: module that receives posted messages.

Message Server: module that processes the receipt and delivery of messages.

Mobile application: module resident, at least in part, on a mobile device.

Mobile device: general term for network-connected devices.

Mobile printing system: system for delivery and receipt of application print requests over a network.

Modify (verb): to change the configurations of a system, including devices and defined functions.

Monitor: module that dispatches messages to their indicated destination.

Network printer: network-connected printers.

Post: command requesting data enclosed in body of message be accepted and stored.

Print Request Handler: module that receives and sends application print requests.

Proxy server: a server (computer or application) which serves as an intermediary for requests from one computer or application on a network to another computer or application on a network.

Request: information requesting an action be taken or service be performed.

Request Handler: module that receives and sends application requests.

Scheduler: module that stores messages and sets time for their future dispatch.

### DETAILED DESCRIPTION OF THE DRAWINGS AND SAMPLE EMBODIMENTS

In the Summary above, this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” “program,” “device,” or “system.” Furthermore, aspects of the disclosed invention may take the form of a computer program product embodied in one or more computer readable media having computer readable program code embodied thereon.

Any element in a claim that does not explicitly state “means for” performing a specified function, or “step for” performing a specific function is not to be interpreted as a “means” or “step” clause as specified in 35. U.S.C. § 112 ¶6. Specifically, the use of “step of” in the claims herein is not intended to invoke the provisions of U.S.C. § 112 ¶6.

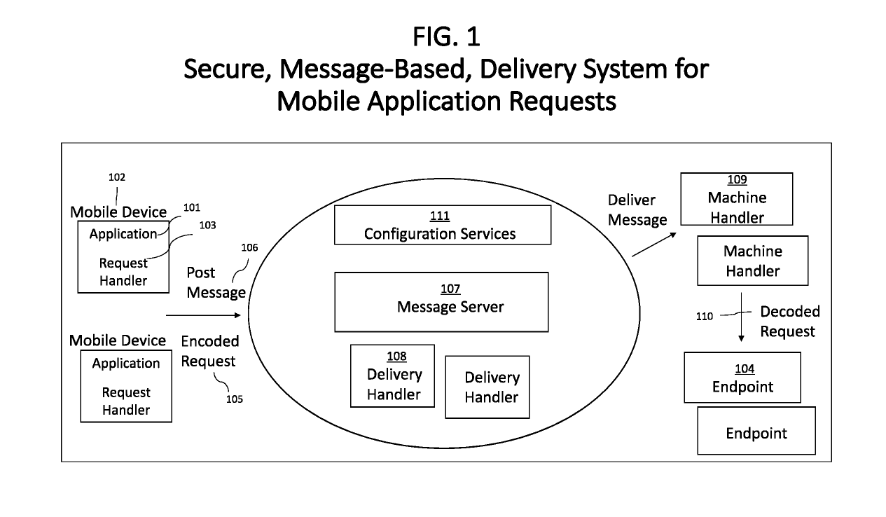

FIG. 1 depicts, as an embodiment, a secure, message-based, delivery system for mobile application requests. Application 101 in Mobile Device 102 sends a request to Request Handler 103 for an action to be performed by Endpoint 104. Request Handler 103 encodes the request into an Encoded Request 105 and posts Encoded Request 105 in Message 106 to Message Server 107. Message Server 107 processes Message 106 and dispatches it to Delivery Handler 108. Delivery Handler 108 delivers Message 106 to Machine Handler 109. Machine Handler 109 decodes Encoded Request 105 into a Decoded Request 110 and submits this request to Endpoint 104.

A mobile application, resident at least in part on the mobile device, is integrated into business workflow and other operations. The mobile application is therefore sending requests for work to be completed by other components within the business system as herein disclosed. The mobile application request made via the instant invention is efficient and secure. Efficiency and security requirements are met by the structure and definitions as setup in the herein-disclosed embodiment's configuration.

Referring to FIG. 1, embodiments of the present invention provide Configuration Services 111 to define and modify (configure) a system to deliver mobile application requests. For example, network resources, a Message Server 107, Delivery Handlers 108, Machine Handlers 109, Endpoints 104, mobile Applications 101 (users), and, schedules for delivering messages can be defined. In certain embodiments, Machine Handlers 109 can be configured with eight-alphanumeric character identifiers. A secure connection between Machine Handlers 109 and their respective Endpoints 104 can also be configured. Mobile Devices' Applications 101 can be configured with a forty-alphanumeric character Application Programming Interface (API) key. Each Machine Handler 109 can be configured to deliver specific requests to specific Endpoints 104.

By way of example and preferred embodiment [further described infra], a Machine Handler 109 is connected, using a pre-authorized, secure network connection, to two Endpoints 104: a physically attached, label printer (“Endpoint A”) and a network attached letter printer (“Endpoint B”). Machine Handler 109 could then be configured to send all “label” requests to Endpoint A, and all other requests to Endpoint B.

Finally, and most critically, Configuration Services 111 provides the ability to establish secure connections between Machine Handlers 109 and their network-secured Endpoints 104. An Application 101 requesting services from a secured Endpoint 104 bypasses any requisite security prompts because the configured Machine Handler 109 is acting as a proxy server. In this way, requests are sent and received securely, and without disruptive and repeated authentications.

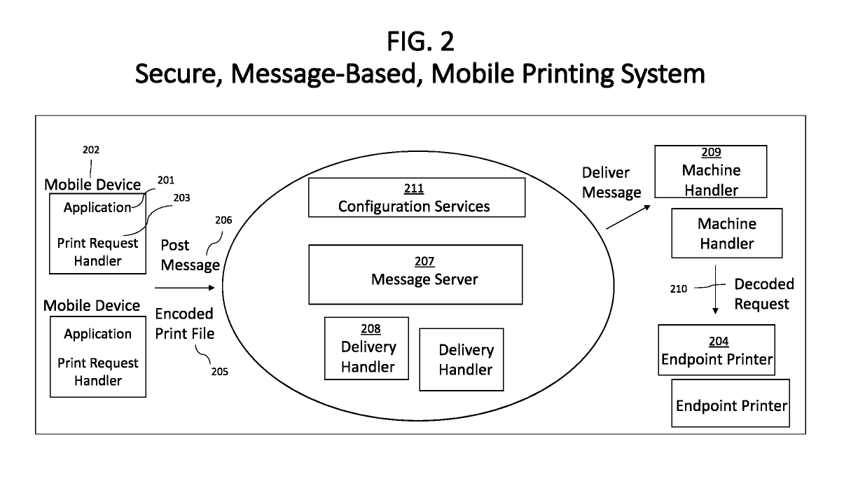

Mobile applications, using the System of the invention, can request to print documents, labels, receipts and orders. FIG. 2 depicts one embodiment of the invention that is directed to such a secure, message-based, mobile printing system. Application 201 in Mobile Device 202 sends a print request to Print Request Handler 203 for printing to be performed by Endpoint Printer 204. Print Request Handler 203 encodes the request into an Encoded Print File 205 and posts Encoded Print File 205 in Message 206 to Message Server 207. Message Server 207 processes Message 206 and dispatches it to Delivery Handler 208. Delivery Handler 208 delivers message to Machine Handler 209. Machine Handler 209 decodes Encoded Print File 205 into a Decoded Print File 210 and submits it to Endpoint Printer 204.

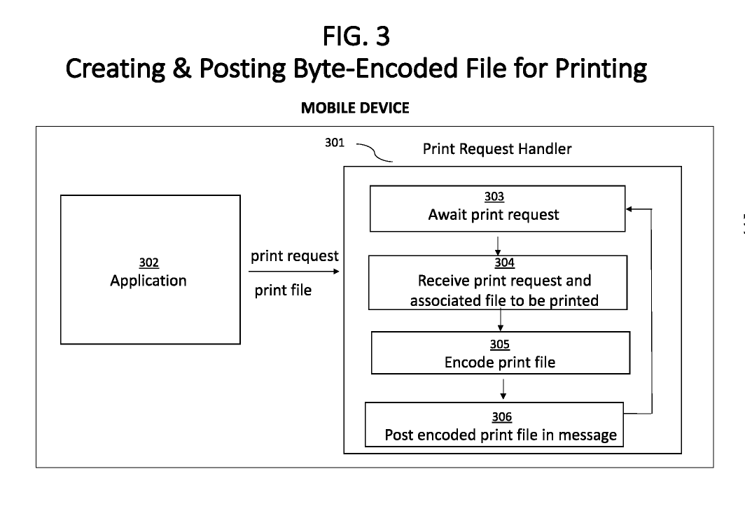

Referring to FIG. 3, the steps of one embodiment of one aspect of the invention are shown. Print Request Handler 301 awaits a print request 303 from Application 302. Print Request Handler 301 receives print request and its associated print file 304 from Application 302. Print Request Handler 301 encodes the received print file 305, which by way of example may be an image file. Finally, Print Request Handler 301 posts the encoded print file in the body of a message 306. In other embodiments, Print Request Handler 301 may store the encoded print file in network-accessible storage and posts the location of the file, such as a uniform resource locator (URL), in the body of a message.

One embodiment of the Print Request Handler 301 and its post of the encoded print file in the body of a message 306, which—in this example—is written in Python (a programming language well understood by persons of ordinary skill in the art), is shown below:

def_{——}gn_send_msg(printPage)

response = Net::HTTP.new(NOTIFICATION_SERVER, NOTIFICATION_ PORT).st

art{ |http|http.request(Net::HTTP::Post.new(“/printSocket/1/”)) }

node_key = response.body.split(“:”).first
socket = WebSocket.new(“ws://#{NOTIFICATION_SERVER}:#{NOTIFICATION_{—}

PORT} /printSock t/1/websocket/#{node_key}”)

socket.send(“4:::#{{:_{——}send => true, :data => printPage}.to_json}”)
socket.close

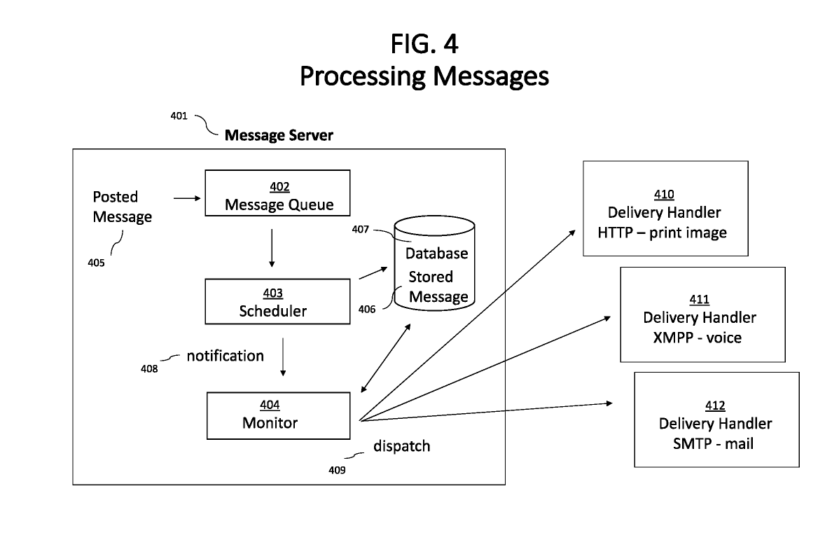

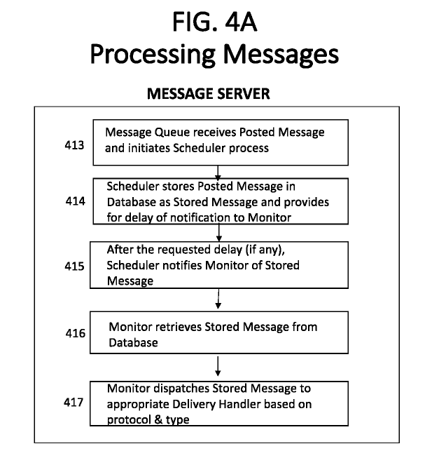

FIG. 4 depicts one embodiment of the invention that is directed to processing messages. Message Server 401 initiates a command processor that runs in the background and processes commands from Message Queue 402, Scheduler 403, and Monitor 404. Message Queue 402 receives posted messages 405. Scheduler 403 stores messages 406 in Database 407 and notifies 408 Monitor 404 at scheduled time of delivery. Monitor 404 listens on a configured delivery channel for incoming messages processed by Message Queue 402. Monitor 404 dispatches 409 messages to the appropriate Delivery Handler 410 411 412.

Referring to FIG. 4A, the steps of one embodiment of one aspect of the invention are shown. Upon receipt of posted message, Message Queue initiates processes executed by Scheduler to handle posted message 413. Scheduler stores posted message as Stored Message in Database, and provides for the ability to delay notification to Monitor 414. After the requested delay (if any), Scheduler notifies Monitor of Stored Message 415. Upon notification, Monitor retrieves Stored Message from Database 416, and dispatches the message to the appropriate Delivery Handler based on protocol used to post the message (e.g., HTTP, XMPP or SMTP) and content of message (e.g., file, voicemail or email) 417.

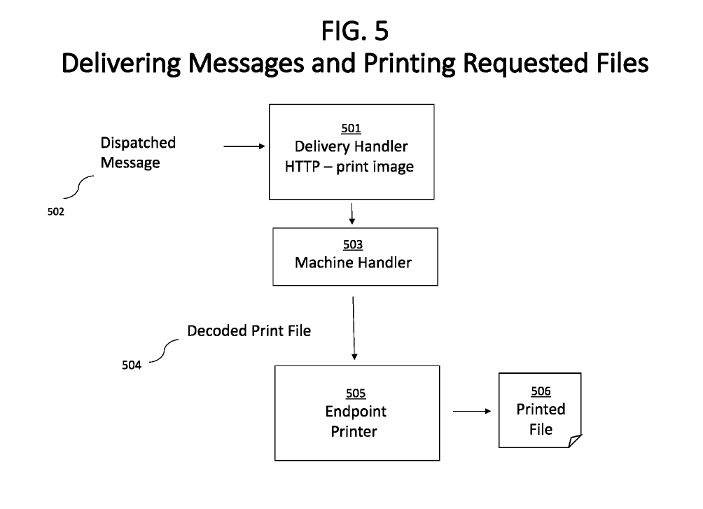

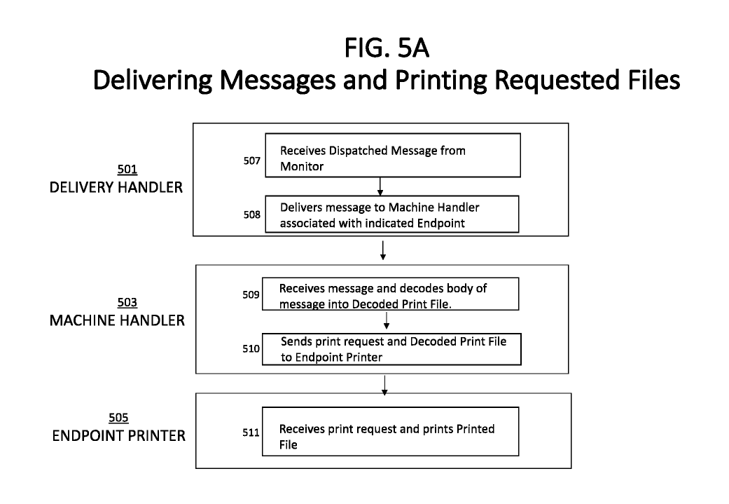

FIG. 5 depicts one embodiment of the invention that is directed to delivering messages and printing requested files. Delivery Handler 501 receives dispatched messages 502, and sends them to the appropriate Machine Handler 503. Machine Handler 503 sends decoded print files 504 to the indicated Endpoint Printer 505. Endpoint Printer 505 performs requested print operation to create printed file 506.

Referring to FIG. 5A, the steps of one embodiment of one aspect of the invention are shown. Delivery Handler receives Dispatched Message from Monitor 507. Delivery Handler then delivers Dispatched Message to Machine Handler associated with the indicated Endpoint 508. Machine Handler receives Dispatched Message and decodes body of message into Decoded Print File 509. Machine Handler sends the print request and Decoded Print File to indicated Endpoint Printer 510. Endpoint Printer receives the request and prints Printed File 511.

One embodiment of the Machine Handler 503 and its decoding of body of message into Decoded Print File 504, and sending the print request and Decoded Print File 504 to the Endpoint Printer 505, which—in this example—is written in Python (a programming language well understood by persons of ordinary skill in the art), is shown below:

def on_message(self, *args):

message = args[1].split(‘:’, 3)
key = int(message[0])
if len(message) >= 4:

data = message[3]

else:

data = ‘ ’

if key == 1 and args[1] == ‘1: :’ :

self.send_packet_helper(1)
self.send_packet_helper(4, data={‘_{——}queue’:

self.gn_key + ‘_’ + self.gn_queue})

self.log.info(‘Connected to gn_queue socket’)

elif key == 2:

self.send_packet_helper(2)

elif key == 5:

data = json.loads(data, )
args = json.loads(data[‘args’][0].replace(“ ′ ”, ‘ ″ ’))
if args[‘data’][‘subject’] == ‘PDF PRINT’:

message = args[‘data’]
cmd = “ ”
if os.name == ‘nt’:

cmd = ‘gsprint.exe −landscape −printer “{ }” −

’.format(self.printer_name,)

else:

cmd = ‘/usr/bin/lpr −o landscape −o PageSize={ } −P

{ }’.format(self.page_size, self.printer_name)

proc = subprocess.Popen(cmd, stdin=subprocess.PIPE,

stdout=subprocess.PIPE, stderr=subprocess.PIPE, shell=True)

response = requests.get(html.unescape(message['body']),
stream=True)
for block in response.iter_content(1024):

proc.stdin.write(block)

stdout, stderr = proc.communicate( )
exit_code = proc.wait( ).

Using the instant System, print requests from mobile applications to secured, network printers are therefore processed in a secure and efficient manner.

What is claimed is:

1. A system for secure, message-based delivery of mobile application requests, comprising:
at least one mobile device, comprising:
a processor;
memory;
an application:
which sends a request for action to be performed to a request handler;
said request handler:
receiving said request for action;
encoding said request for action in an encoded request;
creating a message with said encoded request within said message;
posting said message to a message server;
a separate computer, comprising:
a computer processor;
memory for said separate computer;
a configuration services server:
which enables delivery of mobile application requests by defining and modifying components of a delivery system;
a message server:
which receives said message posted by said request handler;
which dispatches said message to a delivery handler;
at least one delivery handler:
receiving said message;
delivering said message to a machine handler;
at least one machine handler:
receiving said message;
decoding said encoded request in a decoded request;
then sending said decoded request to an endpoint;
said endpoint receiving said decoded request and performing said decoded request.

2. The system of claim 1, wherein said configuration services server;
defines and modifies said mobile devices,
defines and modifies said applications,
defines and modifies said request handlers,
defines and modifies said message server,
defines and modifies said delivery handlers,
defines and modifies said machine handlers,
and defines and modifies said endpoints;
and wherein said configuration server:
defines and modifies schedules ror delivery of said messages; and
establishes secure connections between said machine handlers and said endpoints.

3. The system of claim 1, wherein:
said mobile device further comprises:
said application:
which sends a print request to be performed to a print request handler;
said print request handler receiving said print request and its associated print file, therein encoding said print file in an encoded print file;
creating a message with said encoded print file within said message:
posting said message to said message server;
said machine handler:
receiving said message;
decoding said encoded print file in a decoded print file;
sending said decoded print file to a printer endpoint; and
said printer endpoint:
receiving said decoded print file and printing said decoded print file.

4. The system of claim 3, wherein:
said print request handler:
receives said print request with a corresponding print file;
encodes said print file for action in an encoded print file;
stores said encoded print file in network-accessible storage at a storage location;
creates a message with said storage location within said message;
posts said message to a message server; and wherein
said machine handler:
receives said message;
retrieves said endoded print file at said storage location;
decodes said encoded print file in a decoded print file; and
sends said decoded print file to a printer endpoint.

5. The system of claim 1, wherein:
said message server further comprises:
a database;
a message queue which receives said message posted by said request handler, and which passes said message to a scheduler;
said scheduler:
storing said message in said database;
retrieving a scheduled delivery time for said message from said configuration services server;
notifying, at said scheduled delivery time, a monitor of said message;
said monitor:
waiting for notifications from said scheduler;
retrieving said message, upon notification, from said database;
dispatching said message to said delivery handler.
